(19) United States
(12) Patent Application Publication
(10) Pub. No.: US 2025/0289380 A1
(43) Pub. Date: Sep. 18, 2025

(54) Arrangement for a Motor Vehicle Comprising a Housing and a Device for Fixing Electric Connecting Cables

(71) Applicant: FLEXIS, Boulogne-Billancourt (FR)

(72) Inventors: Benoit ALLARD, Villiers Saint-Frederic (FR); Nicolas JAMES, Guyancourt (FR); Pascal PAROLINI, Guyancourt (FR)

(21) Appl. No.: 19/081,415

(22) Filed: Mar. 17, 2025

(30) Foreign Application Priority Data
Mar. 18, 2024 (FR) FR 2402653

(51) Int. Cl. B60R 16/02

(52) U.S. Cl. CPC B60R 16/0215

(57) ABSTRACT

An arrangement (3) for an engine (2) of a motor vehicle (1), comprising a housing (4) and a device (5) for attaching at least one cable (6) comprising a base (7) delimiting at least one location (71) configured to receive the at least one cable (6), the base (7) and the housing (4) being in one-piece and a removable and directly mounted attachment flange (8) configured to cooperate with the housing (4) and/or the base (7) so as to hold a cable (6) in the at least one location (71).

The invention relates to an arrangement for an engine of a motor vehicle comprising a housing for an engine and a device for attaching cables, in particular electrical connection cables. The invention further relates to a vehicle comprising such an arrangement. The invention further relates to an attachment method for cables in an arrangement according to the invention.

In the automotive environment, it is known to how to attach high voltage cable harnesses to the housing, or casing, of the electric motor of the vehicle. Conventionally, such an attachment is achieved by means of a directly mounted removable lug, in particular of metal, attached to an upper part of the housing by screwing and of a flange cooperating with said lug so as to hold said cables between the removable lug and the flange. Such an attachment nevertheless generates a non-negligible vertical space requirement.

The invention falls within such context and aims to provide a less bulky alternative to known cable attachments. In addition, the invention aims to simplify the attachment of cables during the assembly of the vehicle.

The invention thereby relates to an arrangement for an engine of motor vehicle, comprising a housing for said engine and a device for attaching at least one cable, in particular an electrical connection cable, the attachment device comprising:
a base delimiting at least one location configured to receive the at least one cable, the base and the housing being in one-piece;
a removable and directly mounted attachment flange configured to cooperate with the housing and/or the base so as to hold a cable in the at least one location.

In particular:
the housing and the base are made of a metallic material; and/or
the mounting flange is made of a metallic material.

Optionally, the arrangement further comprises an intermediate shell, in particular made of a plastic material, configured to be interposed between at least part of the attachment flange and the at least one cable.

In particular, the intermediate shell comprises a groove matching the shape of the attachment flange and configured to receive the attachment flange.

Optionally, the arrangement further comprises a means for holding a cable.

Optionally also, the arrangement further comprises a stop member configured to be interposed between the base and the attachment flange so as to limit a crushing of the at least one cable.

Optionally, the arrangement further comprises a damping member configured to be interposed between the base and the attachment flange so as to limit vibrations.

According to examples of embodiment:
the attachment flange is attached to the base and/or the housing by means of a directly mounted means of attachment, such as a screw or a means of clipping; and/or
the attachment flange is attached to the base and/or the housing by means of a pivoting connection.

The invention further relates to a motor vehicle comprising at least one cable, in particular an electrical connection cable, and an arrangement according to the invention, the at least one cable being arranged in the at least one location so as to be interposed between a part of the base and of the flange.

Finally, the invention extends to a method of attachment of at least one cable in a vehicle according to the invention, comprising the positioning of the at least one cable in the at least one location, the positioning and then the attachment to the attachment flange on the housing and/or the base so that the at least one cable is interposed between the base and the attachment flange.

Other details, features and advantages will become clearer upon reading the detailed description given hereinafter, as an indication, but not limited to, in relation to the different examples of embodiment illustrated in the following figure:

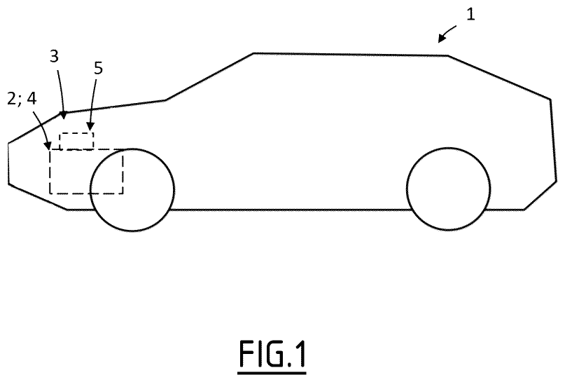

FIG. 1 is a schematic representation of an example of embodiment of a vehicle equipped with an arrangement comprising an engine housing and a cable attachment device.

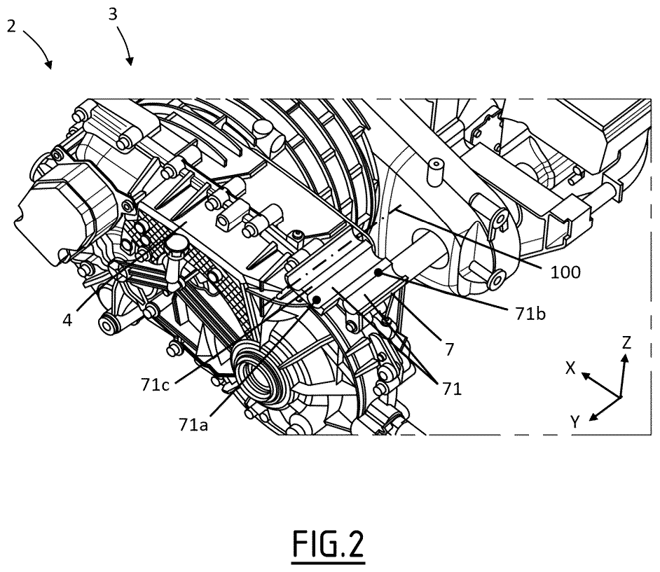

FIG. 2 is a schematic representation of the arrangement and of a base of the attachment device.

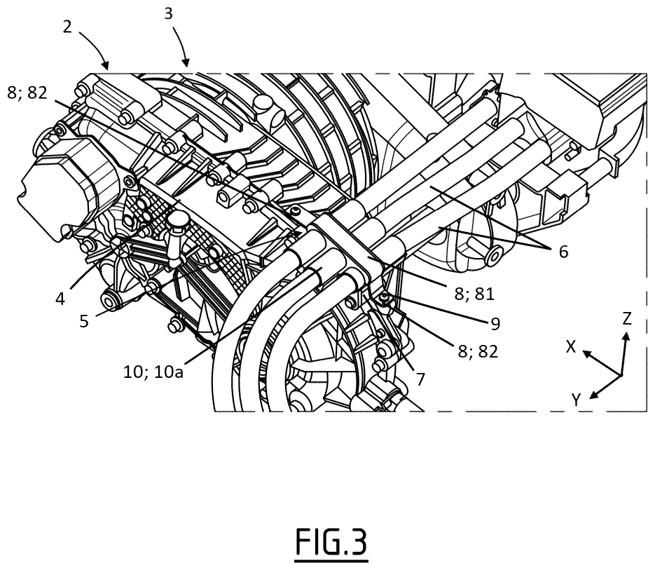

FIG. 3 is a schematic representation of the arrangement of the assembled attachment device.

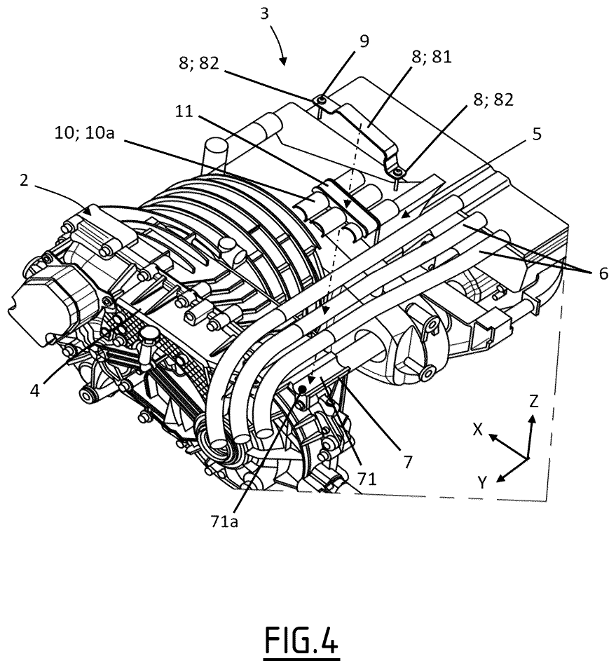

FIG. 4 is a schematic representation of the arrangement and of an exploded view of the attachment device.

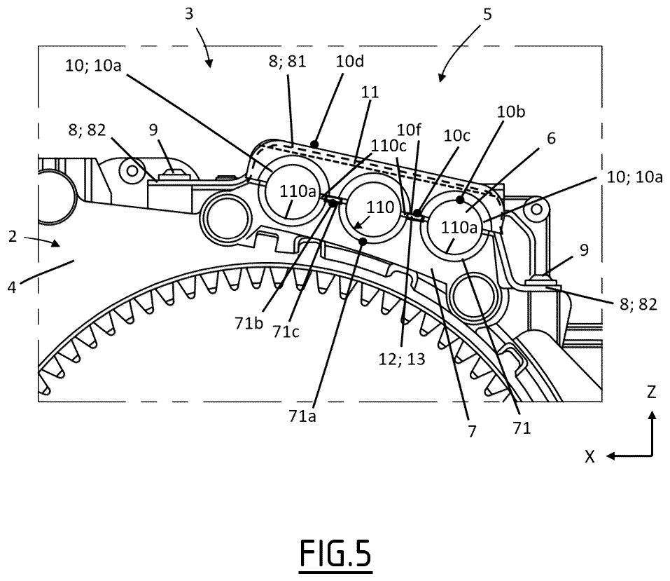

FIG. 5 is a sectional schematic representation of the arrangement and of the assembled attachment device.

FIG. 1 schematically shows an example of embodiment of a vehicle 1, in particular a motor vehicle. The vehicle 1 in question has an electric or hybrid motor and comprises at least one electric motor 2, also referred to as an electric machine. e.g., the vehicle 1 may be a private vehicle or a utility vehicle.

According to conventions relating to the automotive field, throughout the description hereinafter, the direction in which the motor vehicle 1 moves in a straight line is defined as the longitudinal direction X, oriented from the front to the rear. The direction perpendicular to the longitudinal direction X and situated in a plane parallel to a ground on which the vehicle 1 rests is called the transverse direction Y. The direction perpendicular to the X and Y directions is named vertical direction Z. Thereby, a direct coordinate system XYZ is defined. The terms “upper” and “lower” are understood in the general meaning thereof, with the term “lower” referring to greater proximity to the ground. Also, the terms “first”, “second” and “third” are intended to distinguish similar elements and not to define a hierarchy within said elements.

The vehicle 1 comprises an arrangement 3 for an engine 2 of a motor vehicle 1, in particular an electric motor 2, comprising, in general, a housing 4 and a device 5 for attaching at least one cable 6. In particular, the at least one cable 6 is an electrical connection cable 6, e.g. high voltage, configured to supply the motor 2 with electrical energy. Conventionally, not discussed in detail, the at least one cable 6 is surrounded by a sheath. Also, “housing” refers to an outer casing of the engine 2. For example, the housing 4 is made of a metallic material, such as steel and/or aluminum. In particular, the housing 4 comprises a plurality of walls.

In general, the attachment device 5 comprises a base 7 and a directly mounted removable attachment flange 8 relative to the base 7.

The base 7 and the housing 4 are advantageously made of the same material, i.e. same form a one-piece assembly and cannot be separated from each other without resulting in the deterioration or even destruction of the parts. Also, the base 7 is made of a metallic material, such as steel and/or aluminum. In particular, the base 7 is arranged in one of the walls, e.g. an upper wall, of the housing 4. Such a principle advantageously makes possible the reduction of the space generated for the attachment of the at least one cable 6, in particular along the vertical direction Z.

The base 7 delimits at least one location 71 configured to receive a cable 6, in particular one of the electrical connection cables 6. The at least one location 71 extends along a direction of extension 100, herein, in a non-limiting manner, parallel to the transverse direction Y. In particular, the base 7 comprises a plurality of locations 71. In this case, the base 7 comprises three locations 71 each configured to receive a cable 6, in particular a cable 6 of a cable harness 6. It is nevertheless understood that the invention extends to an attachment device 5 and to a base 7 comprising a greater or lesser number of locations 71. The following description is made with reference to one of the locations 71 and can be applied to all or part of the plurality of locations 71.

The location 71 has a shape-matching profile with the at least one cable 6. In particular, the location 71 has a curved profile, e.g. semicircular or in the form of an arc of a circle. The curved shape of the location 71 is formed by a bottom 71a of the location 71. The base 7 further comprises a first surface 71b delimiting an upper portion of the base 7 and to which the bottom 71a of the location 71 is connected. For example, the first surface 71b is flat or substantially flat.

When the base 7 comprises a plurality of locations 71, the locations are, in particular, separated by a spacing 71c, making it possible in particular to limit the contact between different adjacent cables 6. In particular, the spacings 71c separating the different locations 71 are inscribed in the first surface 71b.

The attachment flange 8 is a removable and directly mounted part configured to cooperate with the housing 4 and/or the base 7 so as to hold a cable 6 in the at least one location 71. In particular, the attachment flange 8 is made of a metallic material, e.g. aluminum and/or steel, and is obtained e.g. by molding or bending.

The attachment flange 8 comprises a body 81 and at least one lug 82 connected to the body 81. According to a non-limiting example of embodiment, the body 81 is inscribed at least in part in a rectilinear shape and/or in a “U” shape or a substantially “U” shape. The body 71 is configured to extend transversely to the at least one cable 6 and to the direction of extension 100 when the arrangement 3 is assembled. Optionally, but preferentially, the at least one lug 82 is flat or substantially flat and configured to extend into contact with the base 7 and/or with the housing 4.

According to an example of embodiment, illustrated in FIG. 4 or 5, the attachment flange 8 is configured to be attached to the base 7 and/or the housing 4 by means of a directly mounted means of attachment 9, such as a screw or a means of clipping. In such an embodiment, the attachment flange 8 comprises two lugs 82, said lugs 82 being arranged on both sides of the body 81 at opposite ends of the body. Each of said lugs 82 thereby comprises an orifice suitable for receiving a means of attachment 9.

According to an alternative embodiment, not shown, the attachment flange 8 is attached to the base 7 and/or the housing 4 by means of a pivoting connection. A first end of the body 81 of the attachment flange 8 then comprises the pivoting connection while a second end, opposite the first end, comprises a lug 82 as described hereinabove.

Thereby, when the attachment flange 8 is mounted and attached onto the casing 4 and/or the base 7, the at least one cable 6 extends in the at least one location 71 and is interposed between the base 7 and the attachment flange 8 along at least one direction, in particular herein along the vertical direction Z within the vehicle 1, orthogonal to the direction of extension 100.

Optionally, the arrangement 3 according to the invention further comprises an intermediate shell 10 configured to be interposed between at least a portion of the attachment flange 8 and the at least one cable 6. In the present case, the intermediate shell 10 extends between the body 81 of the attachment flange 8 and the base 7. In particular, the intermediate shell 10 is made of a plastic material, optionally a plastic material filled, e.g. with glass fibers.

The intermediate shell 10 delimits at least one housing 10a mating with the shape of the at least one cable 6. The at least one housing 10a is configured to extend opposite the at least one location 71 of the base 7 when the intermediate shell 10 is arranged in the arrangement 3. More particularly, the intermediate shell 10 comprises as many housings 10a as the base 7 comprises locations 71 configured to receive a cable 6. Thereby, when the intermediate shell comprises a plurality of housings 10a, each is configured to extend opposite a location 71 of the base 7, in particular so as to cooperate with a cable 6. In the example illustrated, the intermediate shell 10 comprises, in a non-limiting manner, three housings 10a. The following description is made with reference to a housing 10a, but applies mutatis mutandis to the different housings 10a.

Similarly to the locations 71, the at least one housing 10a has a profile matching the shape of the at least one cable 6. In particular, the at least one housing 10a has a curved profile, e.g. semicircular or in the form of an arc of a circle. The curved shape of the location 71 is formed by an internal surface 10b of the at least one housing 10a.

The intermediate shell 10 also comprises an intermediate surface c configured to be oriented toward the base 7 when the arrangement 3 is assembled and, in particular, to be arranged at the first surface 71b, e.g. in contact with the first surface 71b of the base 7. Optionally, the intermediate surface 10c is flat or substantially flat. In particular, the different housings 10a are separated by a defined spacing 10f, in particular similar to the spacing 71c separating the housings 10a, and partly inscribed in the intermediate surface c.

According to one embodiment, the intermediate shell 10 is directly mounted and removable relative to the base 7 and to the attachment flange 8. For example, optionally but preferentially, the intermediate shell 10 comprises a groove 11 matching the shape of the attachment flange 8 and configured to receive said attachment flange 8. The groove is arranged at the external surface 10d of the intermediate shell 10, opposite the intermediate surface 10c. In particular, a first face of the attachment flange 8, flat or substantially flat and configured to face toward the base 7, is arranged in contact with a bottom of the groove 11.

In this way, edges of the groove 11 limit the displacements of the attachment flange 8 relative to the intermediate shell 10. In particular, a depth of said groove 11 is equal to, or substantially equal to, a thickness of the attachment flange 8 so that the space, in particular herein the vertical space Z, generated by the cooperation between the attachment flange 8 and the intermediate shell 10 is limited, or even zero. For example, a second face of the attachment flange 8, opposite the first face, is flush with, or substantially flush with, the external surface 10d of the intermediate shell 10.

According to an alternative embodiment, the intermediate shell 10 is rigidly attached to the attachment flange 8 and is directly mounted relative to the base 7, the intermediate shell 10 being overmolded on said flange. The intermediate shell 10 may then comprise a groove 11 as described hereinabove.

According to yet another alternative embodiment wherein the arrangement 2 does not have the intermediate shell 10, the body 81 of the attachment flange 8 comprises at least one housing 10a as described hereinabove, the preceding description applying mutatis mutandis to the attachment flange 8, in particular to the first face of the attachment flange 8.

Optionally, the arrangement 3 according to the invention further comprises a supplementary intermediate shell 110 configured to be interposed between the base 7 and the at least one cable 6. The supplementary intermediate shell 110 is interposed between the intermediate shell 10 and the base 7. In particular, the supplementary intermediate shell 110 is a thin piece, made of a plastic material, optionally a plastic material filled, e.g. with glass fibers.

The supplementary intermediate shell 110 includes at least one recessed zone 110a matching the shape of the at least one cable 6. The at least one recessed zone 110a is configured to be received in the at least one location 71 of the base 7 when the supplementary intermediate shell 110 is arranged in the arrangement 3. More particularly, the supplementary intermediate shell 110 comprises as many recessed zones 110a as the base 7 comprises locations 71 configured to receive a cable 6. Thereby, when the supplementary intermediate shell 110 comprises a plurality of recessed zones 110a, each is configured to be received in a location 71 of the base 7, in particular so as to cooperate with a cable 6 and to be interposed between the cable 6 and the surface of the base 7. In the example illustrated, the supplementary intermediate shell 110 comprises, in a non-limiting manner, three recessed zones 110a. The following description is made with reference to a recessed zone 110a, but applies mutatis mutandis to the other recessed zones 110a.

Similarly to the locations 71, the at least one hollow zone 110a has a profile matching the shape of the at least one cable 6. In particular, the at least one recessed zone 110a has a curved profile, e.g. semicircular or in the form of an arc of a circle. The curved shape of the recessed zone 110a is formed by an inner surface of the at least one recessed zone 110a.

The supplementary intermediate shell 110 further comprises an intermediate surface 110c, configured to be oriented toward the intermediate shell 10 when the arrangement 3 is assembled and, in particular, to be arranged between the first surface 71b and the intermediate surface 10c.

According to one embodiment, the supplementary intermediate shell 110 is directly mounted and removable relative to the base 7 and to the intermediate shell 10.

The intermediate shell 10 and the supplementary intermediate shell 110 together form a sleeve interposed between the base 7 and the attachment flange 8. The sleeve delimits passages for each cable 6. The sleeve consists of two separate parts, independent of each other, placed on both sides of the cables, which facilitates the fitting of the arrangement 3.

The arrangement 3 may comprise only the intermediate shell 10, both the intermediate shell 10 and the supplementary intermediate shell 110, only the supplementary intermediate shell 110, or else may comprise neither the intermediate shell 10 nor the supplementary intermediate shell 110.

Optionally, the arrangement 3 comprises a means for holding (not shown) the at least one cable 6 configured to limit the displacement of the at least one cable 6 along the direction of extension 100 of the at least one location 71. For example, such a means of holding comprises a graining and/or at least one rib arranged at the bottom 71a of at least one location 71 of the base 7 and/or on the first face of the attachment flange 8. Alternatively, when the attachment device 5 comprises the intermediate shell 10, such a means of holding is arranged in at least one location 71 of the base 7, in particular on the inner surface 10b of the intermediate shell 10.

Optionally, the arrangement 3 further comprises a stop member 12 configured to be interposed between the base 7 and the attachment flange 8 so as to limit a crushing of the at least one cable 6. For example, such a member comprises a graining and/or at least one rib formed in the material of the first surface 71b of the base 7 and/or of the first face of the attachment flange 8. Alternatively, when the attachment device 5 comprises the intermediate shell 10, such a stop member 12 is arranged on the first surface 71b of the base 7 and/or on the intermediate surface 10c of the intermediate shell 10. When the stop member 12 is comprised in the base 7, same extends transversely to the direction of extension 100, toward the attachment flange 8, so as to form a stop for the attachment flange 8 or the intermediate shell 10 and thereby limit a crushing of the at least one cable 6 between the base 7 and the attachment flange 8. The opposite principle applies when the stop member 12 is comprised in the attachment flange 8 or the intermediate shell 10, the stop member 12 then forming a stop for the base 7. Similarly, the attachment device 5 may comprise a plurality of stop members 12, comprised in the base 7, the attachment flange 8 and/or the intermediate shell 10. Alternatively, the stop member 12 is formed by a directly mounted and attached part, e.g. bonded, in particular made of plastic or rubber material.

Optionally again, the attachment device 5 comprises a damping member 13 configured to be interposed between the base 7 and the attachment flange 8 so as to limit vibrations between the latter. In particular, the damping member 13 is a directly mounted and attached part, e.g. bonded, made of plastic or rubber material. The damping member 13 and the stop member 12 are optionally, and advantageously, merged. The position of the damping member 13 can then be similar to the examples of positions described hereinabove with reference to the stop member 12.

The invention further extends to a method of attachment of at least one cable 6, in particular an electrical connection cable, in a vehicle 1 and to an arrangement 3 according to the invention. For example, said cable 6 is a high voltage cable. The method comprises, in a first step, positioning of the at least one cable 6 in the at least one location 71 of the base 7. When the base 7 comprises a plurality of locations 71, cables 6 are arranged in all or part of said locations 71.

The method then comprises the positioning and then the attachment of the attachment flange 8 on the housing 4 and/or the base 7 so that the at least one cable 6 is interposed between the base 7 and the attachment flange 8. Alternatively, when the attachment device 5 comprises the intermediate shell 10, the method comprises, prior to the positioning and the attachment of the attachment flange 8, the positioning of the intermediate shell 10 so that the latter is interposed between the at least one cable 6 and the attachment flange 8.

The present invention thus proposes an arrangement comprising a motor housing and a device for attaching at least one cable advantageously making possible a more compact attachment of the electrical connection cables of the vehicle, in particular of the motor, inducing in particular a smaller vertical space requirement compared with the prior art. Furthermore, the invention reduces the number of parts and assembly steps required for the attachment of cables, thereby reducing the costs involved and the time required for the attachment of cables.

However, the present invention cannot be limited to the means and modes described and illustrated herein and also extends to any equivalent means or modes and to any technically effective combination of such means insofar as same ultimately fulfill the functions described and illustrated in the present document.

1. An arrangement for an engine of a motor vehicle, comprising a housing for said engine and an attachment device for at least one cable, the attachment device comprising:
a base delimiting at least one location configured to receive the at least one cable, the base and the housing being in one-piece;
a removable and directly mounted attachment flange configured to cooperate with the housing and/or the base so as to hold a cable in the at least one location.

2. The arrangement according to claim 1, wherein:
the housing and the base are made of a metallic material; and/or
the attachment flange is made of a metallic material.

3. The arrangement according to claim 1, further comprising an intermediate shell configured to be interposed between at least a part of the attachment flange and the at least one cable.

4. The arrangement according to claim 3, wherein the intermediate shell comprises a groove matching the shape of the attachment flange and configured to receive the attachment flange.

5. The arrangement according to claim 1, further comprising means of holding a cable.

6. The arrangement according to claim 1, further comprising a stop member configured to be interposed between the base and the attachment flange so as to limit a crushing of the at least one cable.

7. The arrangement according to claim 1, further comprising a damping member configured to be interposed between the base and the attachment flange so as to limit vibrations.

8. The arrangement according to claim 1, wherein:
the attachment flange is attached to the base and/or the housing by means of a directly mounted means of attachment; and/or
the attachment flange is attached to the base and/or the housing by means of a pivoting connection.

9. A motor vehicle comprising at least one cable and an arrangement according to claim 1, the at least one cable being arranged in the at least one location so as to be interposed between a part of the base and of the flange.

10. A method of attachment of at least one cable in a vehicle according to claim 9, comprising the positioning of the at least one cable in the at least one location, the positioning and then the attachment of the attachment flange onto the housing (4) and/or the base so that the at least one cable is interposed between the base and the attachment flange).

11. The arrangement according to claim 1, wherein the at least one cable is an electrical connection cable.

12. The arrangement according to claim 3, wherein the intermediate shell is made of a plastic material.

13. The arrangement according to claim 8, wherein the means of attachment are a screw or a means of clipping.

14. A motor vehicle according to claim 9, wherein the at least one cable is an electrical connection cable.
